(19) United States
(12) Patent Application Publication
(10) Pub. No.: US 2016/0286489 A1
(43) Pub. Date: Sep. 29, 2016

(54) Terminal Energy-Saving Method, Terminal, And System

(71) Applicant: Huawei Technologies Co., Ltd., Shenzhen (CN)

(72) Inventor: Yan Liu, Shenzhen (CN)

(21) Appl. No.: 15/176,898

(22) Filed: Jun. 8, 2016

Related U.S. Application Data
(63) Continuation of application No. PCT/CN2014/085400, filed on Aug. 28, 2014.

(30) Foreign Application Priority Data
Dec. 12, 2013 (CN) 201310676537.5

(51) Int. Cl. H04W 52/02; H04W 76/06; H04W 76/02

(52) U.S. Cl. CPC H04W 52/0225; H04W 76/02; H04W 52/0277; H04W 76/06

(57) ABSTRACT

Embodiments of the present disclosure disclose a terminal energy-saving method, a terminal, and a system, and the terminal includes a wireless power module, a communications module, a data collection module, where the wireless power module includes an energy induction submodule and a power management submodule. The energy induction submodule is configured to generate electric energy by responding to excitation output by an external apparatus, the power management submodule is configured to input the electric energy generated by the energy induction submodule as excitation electric energy into the communications module, the communications module is configured to establish, driven by the excitation electric energy, a wireless connection with the external apparatus, and the communications module is further configured to read collected data from the data collection module and send the data to the external apparatus through the wireless connection.

### CROSS-REFERENCE TO RELATED APPLICATIONS

This application is a continuation of International application No. PCT/CN2014/085400, filed on Aug. 28, 2014, which claims priority to Chinese Patent Application No. 201310676537.5, filed on Dec. 12, 2013, both of which are hereby incorporated by reference in their entireties.

### TECHNICAL FIELD

The present disclosure relates to the field of communications technologies, and in particular, to a terminal energy-saving method, a terminal, and a system.

### BACKGROUND

A wearable physiological data collection terminal should work for a long time, for example, more than ten days or several months, and the wearable physiological data collection terminal requires a working manner with high environment tolerance, low power consumption, and high reliability. An existing communication manner of a wearable physiological data collection terminal and an intelligent terminal includes Bluetooth, Cellular Network, and the like. However, a power consumption of the existing communication manners is very high, and such high power consumption imposes a great challenge to an endurance capability of a storage battery of the wearable physiological data collection terminal.

### SUMMARY

Embodiments of the present disclosure disclose a terminal energy-saving method, a terminal, and a system, which are used to relieve a problem of an insufficient endurance capability of a storage battery in an existing collection terminal.

A first aspect of the embodiments of the present disclosure discloses a terminal, where the terminal includes a wireless power module, a communications module, and a data collection module, where the wireless power module includes an energy induction submodule and a power management submodule, where the energy induction submodule is configured to generate electric energy by responding to excitation output by an external apparatus, the power management submodule is configured to input the electric energy generated by the energy induction submodule as excitation electric energy into the communications module, the communications module is configured to establish, driven by the excitation electric energy, a wireless connection with the external apparatus, and the communications module is further configured to read collected data from the data collection module and send the data to the external apparatus through the wireless connection.

In a first possible implementation manner of the first aspect of the embodiments of the present disclosure, the terminal further includes a storage battery module configured to supply power to the data collection module, and the data collection module configured to driven by power supply of the storage battery module, collect data and store the collected data.

With reference to the first possible implementation manner of the first aspect of the embodiments of the present disclosure, in a second possible implementation manner of the first aspect of the embodiments of the present disclosure, a manner in which the power management submodule inputs the electric energy generated by the energy induction submodule as the excitation electric energy into the communications module is as follows the power management submodule determines whether a change rate of the electric energy is greater than a preset change rate and remains unchanged, and if yes, inputs the electric energy as the excitation electric energy into the communications module, or the power management submodule determines whether an electric energy value of the electric energy is greater than a preset electric energy value, and if yes, inputs the electric energy as the excitation electric energy into the communications module.

With reference to the first possible implementation manner or the second possible implementation manner of the first aspect of the embodiments of the present disclosure, in a third possible implementation manner of the first aspect of the embodiments of the present disclosure, the communications module is further configured to receive first prompt information that is sent by the external apparatus and is used to prompt that the data is successfully received, and the power management submodule is further configured to respond to the first prompt information and send remaining electric energy to the storage battery module such that the storage battery module stores the remaining electric energy.

With reference to the third possible implementation manner of the first aspect of the embodiments of the present disclosure, in a fourth possible implementation manner of the first aspect of the embodiments of the present disclosure, the communications module is further configured to respond to the first prompt information, disconnect the wireless connection, and stop an operation of reading the collected data from the data collection module, and the terminal further includes a space releasing module, where the space releasing module is configured to respond to the first prompt information and release storage space that is used to store the collected data and is in the data collection module.

With reference to the first aspect of the embodiments of the present disclosure, in a fifth possible implementation manner of the first aspect of the embodiments of the present disclosure, the power management submodule is further configured to when detecting that the electric energy is insufficient, send second prompt information that is used to prompt that the electric energy is insufficient to the communications module, and the communications module is further configured to respond to the second prompt information, disconnect the wireless connection, and stop an operation of reading the collected data from the data collection module.

With reference to the first aspect of the embodiments of the present disclosure, in a sixth possible implementation manner of the first aspect of the embodiments of the present disclosure, the power management submodule is further configured to when detecting that the electric energy is insufficient, send second prompt information that is used to prompt that the electric energy is insufficient to the communications module, and the communications module is further configured to respond to the second prompt information and send the second prompt information to the external apparatus such that the external apparatus increases excitation power output by the external apparatus.

A second aspect of the embodiments of the present disclosure discloses a terminal, including a memory and a processor, where the memory stores a group of program code, and the processor is configured to invoke the program code stored in the memory to execute the following operations generating electric energy by responding to excitation output by an external apparatus, establishing, driven by the electric energy, a wireless connection with the external apparatus, and reading collected data and sending the data to the external apparatus through the wireless connection.

In a first possible implementation manner of the second aspect of the embodiments of the present disclosure, before the processor reads the collected data and sends the data to the external apparatus through the wireless connection, the processor is configured to invoke the program code stored in the memory and is further configured to execute the following operation collecting data and storing the collected data.

With reference to the first possible implementation manner of the second aspect of the embodiments of the present disclosure, in a second possible implementation manner of the second aspect of the embodiments of the present disclosure, the processor is configured to invoke the program code stored in the memory and is further configured to execute the following operations receiving first prompt information that is sent by the external apparatus and is used to prompt that the data is successfully received, and responding to the first prompt information and storing remaining electric energy.

With reference to the second possible implementation manner of the second aspect of the embodiments of the present disclosure, in a third possible implementation manner of the second aspect of the embodiments of the present disclosure, the processor is configured to invoke the program code stored in the memory and is further configured to execute the following operation responding to the first prompt information, disconnecting the wireless connection, stopping an operation of reading the collected data, and releasing storage space that is used to store the collected data and is in the processor.

With reference to the second aspect of the embodiments of the present disclosure, in a fourth possible implementation manner of the second aspect of the embodiments of the present disclosure, the processor is configured to invoke the program code stored in the memory and is further configured to execute the following operation detecting whether the electric energy is insufficient, and when detecting that the electric energy is insufficient, disconnecting the wireless connection and stopping an operation of reading the collected data.

A third aspect of the embodiments of the present disclosure discloses a terminal energy-saving method, and the method includes generating electric energy by a wireless power module by responding to excitation output by an external apparatus, inputting, by the wireless power module, the electric energy as excitation electric energy into a communications module, establishing, by the communications module and driven by the excitation electric energy, a wireless connection with the external apparatus, and reading, by the communications module, collected data from a data collection module, and sending the data to the external apparatus through the wireless connection.

In a first possible implementation manner of the third aspect of the embodiments of the present disclosure, before the reading, by the communications module, collected data from a data collection module, and sending the data to the external apparatus through the wireless connection, the method further includes supplying, by a storage battery module, power to the data collection module, and collecting, by the data collection module and driven by power supply of the storage battery module, data and storing the collected data.

With reference to the first possible implementation manner of the third aspect of the embodiments of the present disclosure, in a second possible implementation manner of the third aspect of the embodiments of the present disclosure, the inputting, by the wireless power module, the electric energy as excitation electric energy into a communications module including determining, by the wireless power module, whether a change rate of the electric energy is greater than a preset change rate and remains unchanged, and if yes, inputting the electric energy as the excitation electric energy into the communications module, or determining, by the wireless power module, whether an electric energy value of the electric energy is greater than a preset electric energy value, and if yes, inputting the electric energy as the excitation electric energy into the communications module.

With reference to the first possible implementation manner or the second possible implementation manner of the third aspect of the embodiments of the present disclosure, in a third possible implementation manner of the third aspect of the embodiments of the present disclosure, the method further includes receiving, by the communications module, first prompt information that is sent by the external apparatus and is used to prompt that the data is successfully received, and responding to, by the wireless power module, the first prompt information, and sending remaining electric energy to the storage battery module such that the storage battery module stores the remaining electric energy.

With reference to the third possible implementation manner of the third aspect of the embodiments of the present disclosure, in a fourth possible implementation manner of the third aspect of the embodiments of the present disclosure, the method further includes responding to, by the communications module, the first prompt information, disconnecting the wireless connection, and stopping an operation of reading the collected data from the data collection module, and responding to, by a space releasing module, the first prompt information and releasing storage space that is used to store the collected data and is in the data collection module.

With reference to the third aspect of the embodiments of the present disclosure, in a fifth possible implementation manner of the third aspect of the embodiments of the present disclosure, the method further includes when detecting that the electric energy is insufficient, sending, by the wireless power module, second prompt information that is used to prompt that the electric energy is insufficient to the communications module, and responding to, by the communications module, the second prompt information, disconnecting the wireless connection, and stopping an operation of reading the collected data from the data collection module.

With reference to the third aspect of the embodiments of the present disclosure, in a sixth possible implementation manner of the third aspect of the embodiments of the present disclosure, the method further includes when detecting that the electric energy is insufficient, sending, by the wireless power module, second prompt information that is used to prompt that the electric energy is insufficient to the communications module, and responding to, by the communications module, the second prompt information, sending the second prompt information to the external apparatus such that the external apparatus increases excitation power output by the external apparatus.

A fourth aspect of the embodiments of the present disclosure discloses a system, and the system includes an external apparatus and the foregoing terminal, where the external apparatus includes an excitation output module and an external apparatus communications module, where the excitation output module is configured to output excitation to the terminal such that the terminal responds to the excitation and generates electric energy, and the external apparatus communications module is configured to establish a wireless connection with the terminal, and the external apparatus communications module is further configured to receive data collected and sent by the terminal through the wireless connection.

In a first possible implementation manner of the fourth aspect of the embodiments of the present disclosure, the external apparatus communications module is further configured to send first prompt information that is used to prompt that the data is successfully received to the terminal such that the terminal responds to the first prompt information and sends remaining electric energy to a storage battery module of the terminal.

With reference to the first possible implementation manner of the fourth aspect of the embodiments of the present disclosure, in a second possible implementation manner of the fourth aspect of the embodiments of the present disclosure, the external apparatus communications module is further configured to disconnect the wireless connection.

With reference to the fourth aspect of the embodiments of the present disclosure, in a third possible implementation manner of the fourth aspect of the embodiments of the present disclosure, the external apparatus communications module is further configured to receive second prompt information that is sent by the terminal and is used to prompt that the electric energy is insufficient to increase excitation power output by the external apparatus.

During implementation of embodiments of the present disclosure, a wireless power module of a terminal generates electric energy by responding to excitation output by an external apparatus, and inputs the generated electric energy as excitation electric energy into a communications module. The communications module establishes, driven by the excitation electric energy, a wireless connection with the external apparatus, reads collected data from a data collection module, and sends the data to the external apparatus through the wireless connection. In this embodiment of the present disclosure, electric energy may be generated by responding to excitation of an external apparatus, and the generated electric energy may be used to supply power to a terminal for acquiring collected data and for communication between the terminal and the external apparatus, which saves the need of supplying power by a storage battery of the terminal to the terminal for acquiring the collected data and for communication between the terminal and the external apparatus, thereby improving an endurance capability of the storage battery in the terminal.

### BRIEF DESCRIPTION OF DRAWINGS

To describe the technical solutions in the embodiments of the present disclosure more clearly, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a schematic flowchart of an embodiment of a terminal energy-saving method.

FIG. 2 is a schematic flowchart of another embodiment of a terminal energy-saving method.

FIG. 3 is a schematic flowchart of still another embodiment of a terminal energy-saving method.

FIG. 4 is a schematic flowchart of still another embodiment of a terminal energy-saving method.

FIG. 5 is a schematic structural diagram of an embodiment of a terminal.

FIG. 6 is a schematic structural diagram of an embodiment a wireless power module.

FIG. 7 is a schematic structural diagram of another embodiment of a terminal.

FIG. 8 is a schematic structural diagram of an embodiment of a system.

FIG. 9 is a schematic structural diagram of another embodiment of a system.

FIG. 10 is a schematic structural diagram of still another embodiment of a terminal.

### DESCRIPTION OF EMBODIMENTS

The following clearly and describes the technical solutions in the embodiments of the present disclosure with reference to the accompanying drawings in the embodiments of the present disclosure. Apparently, the described embodiments are merely some but not all of the embodiments of the present disclosure. All other embodiments obtained by a person of ordinary skill in the art based on the embodiments of the present disclosure without creative efforts shall fall within the protection scope of the present disclosure.

According to a terminal energy-saving method, a terminal, and a system provided in the present disclosure, the terminal may generate electric energy by responding to excitation of an external apparatus, and the generated electric energy may be used to supply power to the terminal for acquiring collected data and for communication between the terminal and the external apparatus, thereby greatly improving an endurance capability of a storage battery in the terminal.

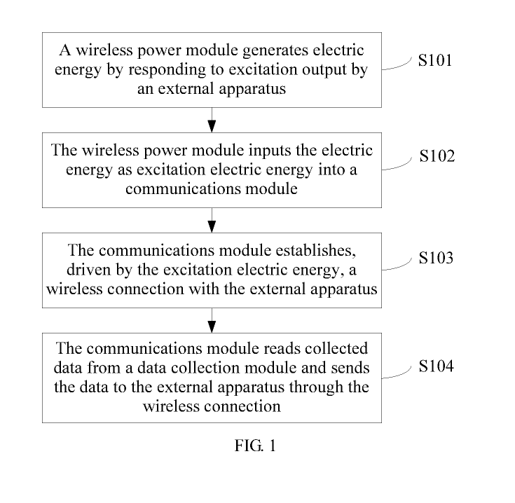

FIG. 1 is a schematic flowchart of a terminal energy-saving method according to an embodiment of the present disclosure. The terminal energy-saving method shown in FIG. 1 is applicable to various terminals that have a data collection function, for example, a wearable physiological data (such as blood pressure, body temperature, and heart rate) collecting terminal, a temperature collecting terminal, and an air quality index (such as fine particles less than 2.5 micrometers in diameter (PM2.5), inhalable particles, sulfur dioxide, nitrogen dioxide, ozone, and carbon monoxide) collecting terminal. As shown in FIG. 1, the terminal energy-saving method may include the following steps:

S101. A wireless power module generates electric energy by responding to excitation output by an external apparatus.

In this embodiment of the present disclosure, a wireless power module may be built in a terminal, where the wireless power module may generate the electric energy by responding to the excitation output by the external apparatus.

In this embodiment of the present disclosure, the external apparatus may output the excitation to the terminal at a specific time interval, or the external apparatus may be triggered, according to a user requirement, to output the excitation to the terminal, which is not limited in this embodiment of the present disclosure. The excitation output by the external apparatus may be a variable magnetic field, or may be a signal that can be converted into electric energy, for example, an optical signal, which is not limited in this embodiment of the present disclosure.

S102. The wireless power module inputs the electric energy as excitation electric energy into a communications module.

In this embodiment of the present disclosure, a communications module may be built in the terminal. In this way, after generating the electric energy by responding to the excitation output by the external apparatus, the wireless power module may input the electric energy as the excitation electric energy into the communications module to drive the communications module to work.

In an optional implementation manner, that the wireless power module inputs the electric energy as excitation electric energy into a communications module may include the following: the wireless power module may determine whether a change rate of the electric energy is greater than a preset change rate and remains unchanged. If a change rate of the electric energy is greater than a preset change rate and remains unchanged, the wireless power module inputs the electric energy as the excitation electric energy into the communications module If the change rate of the electric energy is not greater than the preset change rate but remains unchanged, the change rate of the electric energy is not greater than the preset change rate and changes, or the change rate of the electric energy is greater than the preset change rate but changes, the wireless power module may ignore the electric energy.

In another optional implementation manner, that the wireless power module inputs the electric energy as excitation electric energy into a communications module may include the following the wireless power module may determine whether an electric energy value of the electric energy is greater than a preset electric energy value. If an electric energy value of the electric energy is greater than a preset electric energy value, the wireless power module inputs the electric energy as the excitation electric energy into the communications module, and if the electric energy value of the electric energy is not greater than the preset electric energy value, the wireless power module may ignore the electric energy.

In this embodiment of the present disclosure, the wireless power module determines whether the change rate of the electric energy or the electric energy value of the electric energy meets a preset requirement, which can ensure that sufficient electric energy is supplied for communication between the terminal and the external apparatus.

For example, assuming that the preset change rate is 5 volt per second (V/s), when determining that the change rate of the electric energy is 7 V/s, the wireless power module may input the electric energy as the excitation electric energy into the communications module, or assuming that the preset electric energy value is 9 volts (V), when determining that the electric energy value of the electric energy is 10V, the wireless power module may input the electric energy as the excitation electric energy into the communications module.

S103. The communications module establishes, driven by the excitation electric energy, a wireless connection with the external apparatus.

In this embodiment of the present disclosure, when the change rate of the electric energy or the electric energy value of the electric energy meets the preset requirement, the electric energy can activate the communications module such that the communications module establishes the wireless connection with the external apparatus, which makes preparation for sending collected data.

In this embodiment of the present disclosure, the communications module may establish, driven by the excitation electric energy, the wireless connection with the external apparatus, where the wireless connection includes various types of short-range wireless communication, such as a Near Field Communication (NFC) connection, a Bluetooth connection, an infrared connection, and an ultrasonic wave connection.

S104. The communications module reads collected data from a data collection module and sends the data to the external apparatus through the wireless connection.

In this embodiment of the present disclosure, a data collection module may be built in the terminal, where the data collection module may collect data and store the collected data under power supplied by a storage battery in the terminal. After the communications module establishes, driven by the excitation electric energy, the wireless connection with the external apparatus, the communications module may read the collected data from the data collection module and send the data to the external apparatus through the wireless connection.

In this embodiment of the present disclosure, the data collection module pre-stores the collected data, and a power supply source of the data collection module may be the storage battery in the terminal, or may be the electric energy generated in step S101, which is not limited in this embodiment of the present disclosure. When the change rate of the electric energy or the electric energy value of the electric energy meets the preset requirement, the electric energy activates the communications module such that the communications module reads the collected data from the data collection module. A manner in which the communications module of the terminal reads the collected data from the data collection module may be acquiring an initial address of the collected data and sequentially reading the collected data according to the initial address of the collected data. In this embodiment of the present disclosure, the collected data may be temperature information or a heart rate of a person at some time points, or information about noise in an environment, which is not limited in this embodiment of the present disclosure.

According to the terminal energy-saving method shown in FIG. 1, a wireless power module of a terminal generates electric energy by responding to excitation output by an external apparatus, and inputs the generated electric energy as excitation electric energy into a communications module. The communications module establishes, driven by the excitation electric energy, a wireless connection with the external apparatus, reads collected data from a data collection module, and sends the data to the external apparatus through the wireless connection. In this embodiment of the present disclosure, electric energy may be generated by responding to excitation of an external apparatus, and the generated electric energy may be used to supply power to a terminal for acquiring collected data and for communication between the terminal and the external apparatus, which saves the need of supplying power by a storage battery of the terminal to the terminal for acquiring the collected data and for communication between the terminal and the external apparatus, thereby improving an endurance capability of the storage battery in the terminal.

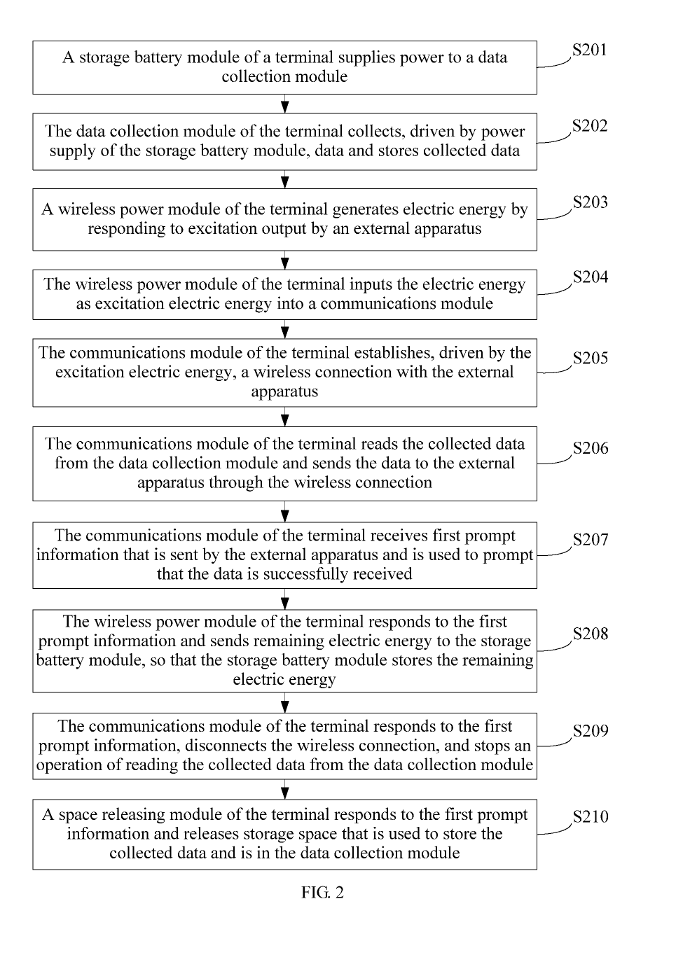

FIG. 2 is a schematic flowchart of another embodiment of a terminal energy-saving method. The terminal energy-saving method shown in FIG. 2 is applicable to various terminals that have a data collection function, for example, a wearable physiological data (such as blood pressure, body temperature, and heart rate) collecting terminal, a temperature collecting terminal, and an air quality index (such as PM2.5, inhalable particles, sulfur dioxide, nitrogen dioxide, ozone, and carbon monoxide) collecting terminal. As shown in FIG. 2, the terminal energy-saving method may include the following steps:

S201. A storage battery module of a terminal supplies power to a data collection module.

S202. The data collection module of the terminal collects, driven by power supply of the storage battery module, data and stores collected data.

In this embodiment of the present disclosure, the data collection module may collect data at a specific time interval and store the collected data, which is not limited in this embodiment of the present disclosure.

In this embodiment of the present disclosure, the data collection module may include one or more sensors, a processor, and a memory. When a time point to perform data collection arrives, one or more sensors may work at the same time. When data collected by the sensor is not generated, the processor is in a standby mode, which facilitates electric energy saving, after all the sensors complete collection, the processor starts to process the collected data and sends the processed data to the memory for storage.

S203. A wireless power module of the terminal generates electric energy by responding to excitation output by an external apparatus.

In this embodiment of the present disclosure, the external apparatus may output the excitation to the terminal at a specific time interval, or the external apparatus may be triggered, according to a user requirement, to output the excitation to the terminal, which is not limited in this embodiment of the present disclosure. The excitation output by the external apparatus may be a variable magnetic field, or may be a signal that can be converted into electric energy, for example, an optical signal, which is not limited in this embodiment of the present disclosure.

S204. The wireless power module of the terminal inputs the electric energy as excitation electric energy into a communications module.

In an optional implementation manner, that the wireless power module inputs the electric energy as excitation electric energy into a communications module may include the following: the wireless power module may determine whether a change rate of the electric energy is greater than a preset change rate and remains unchanged. If a change rate of the electric energy is greater than a preset change rate and remains unchanged, the wireless power module inputs the electric energy as the excitation electric energy into the communications module, and if a change rate of the electric energy is not greater than a preset change rate and remains unchanged, the wireless power module may ignore the electric energy.

In another optional implementation manner, that the wireless power module inputs the electric energy as excitation electric energy into a communications module may include the following: the wireless power module may determine whether an electric energy value of the electric energy is greater than a preset electric energy value. If an electric energy value of the electric energy is greater than a preset electric energy value, the wireless power module inputs the electric energy as the excitation electric energy into the communications module, and if an electric energy value of the electric energy is not greater than a preset electric energy value, the wireless power module may ignore the electric energy.

In this embodiment of the present disclosure, the wireless power module of the terminal determines whether the change rate of the electric energy or the electric energy value of the electric energy meets a preset requirement, which can ensure that sufficient electric energy is supplied for communication between the terminal and the external apparatus.

S205. The communications module of the terminal establishes, driven by the excitation electric energy, a wireless connection with the external apparatus.

In this embodiment of the present disclosure, the communications module of the terminal may establish, driven by the excitation electric energy, the wireless connection with the external apparatus, where the wireless connection includes various types of short-range wireless communication, such as a NFC connection, a Bluetooth connection, an infrared connection, and an ultrasonic wave connection.

S206. The communications module of the terminal reads collected data from the data collection module and sends the data to the external apparatus through the wireless connection.

In this embodiment of the present disclosure, the data collection module pre-stores the collected data, and a power supply source of the data collection module may be the storage battery in the terminal, or may be the electric energy generated in step S203, which is not limited in this embodiment of the present disclosure. When the change rate of the electric energy or the electric energy value of the electric energy meets the preset requirement, the electric energy activates the communications module such that the communications module reads the collected data from the data collection module. A manner in which the communications module of the terminal reads the collected data from the data collection module may be acquiring an initial address of the collected data and sequentially reading the collected data according to the initial address of the collected data. In this embodiment of the present disclosure, the collected data may be temperature information or a heart rate of a person at some time points, or information about noise in an environment, which is not limited in this embodiment of the present disclosure.

In this embodiment of the present disclosure, the storage battery in the terminal supplies power for data collection, and the electric energy generated in step S203 supplies power for acquiring collected data and for communication between the terminal and the external apparatus. Power consumption required for data collection is relatively low, and power consumption required for sending the collected data to the external apparatus is relatively high. Such a power supply manner in which power supply for data collection is differentiated from power supply for acquiring and sending the collected data can greatly improve an endurance capability of the storage battery in the terminal.

In an optional implementation manner, as shown in FIG. 2, the terminal energy-saving method may further include the following steps:

S207. The communications module of the terminal receives first prompt information that is sent by the external apparatus and is used to prompt that the data is successfully received.

S208. The wireless power module of the terminal responds to the first prompt information and sends remaining electric energy to the storage battery module such that the storage battery module stores the remaining electric energy.

In this embodiment of the present disclosure, when the electric energy generated by the wireless power module by responding the excitation output by the external apparatus is greater than electric energy consumed by the communications module, the wireless power module may send the remaining electric energy to the storage battery module such that the storage battery module stores the remaining electric energy. For example, after the communications module sends all collected data to the external apparatus, the communications module is in a sleep state, in which little to no electric energy is consumed. In this case, the wireless power module may transmit, to the storage battery module, most electric energy generated by responding to the excitation output by the external apparatus. The remaining electric energy stored in the storage battery may supply power for data collection, which further improves the endurance capability of the storage battery.

In an optional implementation manner, as shown in FIG. 2, the terminal energy-saving method may further include the following steps:

S209. The communications module of the terminal responds to the first prompt information, disconnects the wireless connection, and stops an operation of reading the collected data from the data collection module.

Power consumption of the wireless connection between the terminal and the external apparatus is very high. When the terminal successfully sends the collected data to the external apparatus, the terminal disconnects the wireless connection with the external apparatus and stops the operation of reading the collected data from the data collection module of the terminal, which can save electric energy.

S210. A space releasing module of the terminal responds to the first prompt information and releases storage space that is used to store the collected data and is in the data collection module.

When the terminal successfully sends the collected data to the external apparatus, the terminal deletes the storage space that is in the data collection module and is used to store the successfully sent data, which may save storage space so as to store collected data next time.

In this embodiment of the present disclosure, a communications module starts to work under excitation of excitation electric energy, and the communications module sends collected data that is read to the external apparatus through a wireless connection established between the communications module and an external apparatus. When a wireless power module of a terminal does not receive excitation of the external apparatus, the communications module does not work, that is, the communications module does not read the collected data nor establishes the wireless connection with the external apparatus. Physically, the communications module and a circuit interface of a data collection module are in a high impedance state, and because a current is extremely small in the high impedance state, the communications module does not become load of the data collection module, nor consumes electric energy that supplies power to the data collection module. Implementation of this embodiment of the present disclosure brings the following beneficial effects: A terminal may generate electric energy by responding to excitation of an external apparatus, the generated electric energy is used to supply power to the terminal for acquiring collected data and for communication between the terminal and the external apparatus, a storage battery in the terminal supplies power for data collection. In such a separate power supply manner, an endurance capability of the storage battery is improved, and in addition, the storage battery can also store remaining electric energy, which further improves the endurance capability of the storage battery. After the communication between the terminal and the external apparatus ends, successfully sent data is deleted and storage space for the successfully sent data is released, which may save storage space.

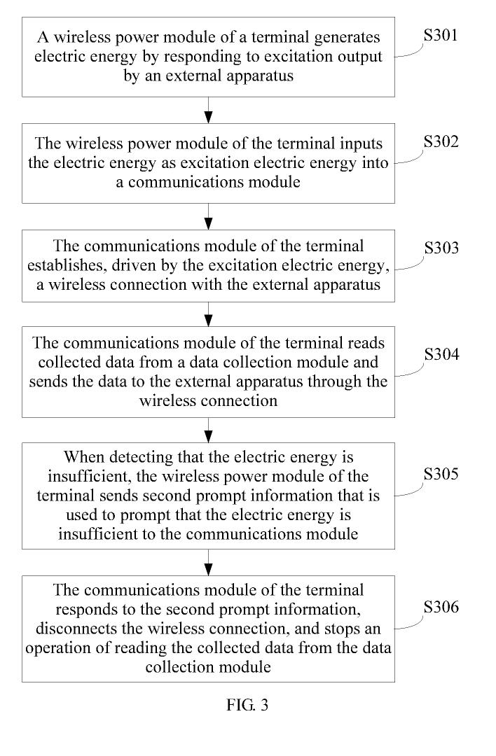

FIG. 3 is a schematic flowchart of still another terminal energy-saving method disclosed in an embodiment of the present disclosure. The terminal energy-saving method shown in FIG. 3 is applicable to various terminals that have a data collection function, for example, a wearable physiological data (such as blood pressure, body temperature, and heart rate) collecting terminal, a temperature collecting terminal, and an air quality index (such as PM2.5, inhalable particles, sulfur dioxide, nitrogen dioxide, ozone, and carbon monoxide) collecting terminal. As shown in FIG. 3, the terminal energy-saving method may include the following steps:

S301. A wireless power module of a terminal generates electric energy by responding to excitation output by an external apparatus.

In this embodiment of the present disclosure, the external apparatus may output the excitation to the terminal at a specific time interval, or the external apparatus may be triggered, according to a user requirement, to output the excitation to the terminal, which is not limited in this embodiment of the present disclosure. The excitation output by the external apparatus may be a variable magnetic field, or may be a signal that can be converted into electric energy, for example, an optical signal, which is not limited in this embodiment of the present disclosure.

S302. The wireless power module of the terminal inputs the electric energy as excitation electric energy into a communications module.

In an optional implementation manner, that the wireless power module inputs the electric energy as excitation electric energy into a communications module may include the following: the wireless power module may determine whether a change rate of the electric energy is greater than a preset change rate and remains unchanged. If a change rate of the electric energy is greater than a preset change rate and remains unchanged, the wireless power module inputs the electric energy as the excitation electric energy into the communications module, and if a change rate of the electric energy is not greater than a preset change rate and remains unchanged, the wireless power module may ignore the electric energy.

In another optional implementation manner, that the wireless power module inputs the electric energy as excitation electric energy into a communications module may include the following: the wireless power module may determine whether an electric energy value of the electric energy is greater than a preset electric energy value. If an electric energy value of the electric energy is greater than a preset electric energy value, the wireless power module inputs the electric energy as the excitation electric energy into the communications module, and if an electric energy value of the electric energy is not greater than a preset electric energy value, the wireless power module may ignore the electric energy.

In this embodiment of the present disclosure, the wireless power module determines whether the change rate of the electric energy or the electric energy value of the electric energy meets a preset requirement, which can ensure that sufficient electric energy is supplied for communication between the terminal and the external apparatus.

S303. The communications module of the terminal establishes, driven by the excitation electric energy, a wireless connection with the external apparatus.

In this embodiment of the present disclosure, when the change rate of the electric energy or the electric energy value of the electric energy meets the preset requirement, the electric energy can activate the communications module such that the communications module establishes the wireless connection with the external apparatus, which makes preparation for sending collected data.

In this embodiment of the present disclosure, the communications module may establish, driven by the excitation electric energy, the wireless connection with the external apparatus, where the wireless connection includes various types of short-range wireless communication, such as a NFC connection, a Bluetooth connection, an infrared connection, and an ultrasonic wave connection.

S304. The communications module of the terminal reads collected data from a data collection module and sends the data to the external apparatus through the wireless connection.

In this embodiment of the present disclosure, the data collection module pre-stores the collected data, and a power supply source of the data collection module may be a storage battery in the terminal, or may be the electric energy generated in step S301, which is not limited in this embodiment of the present disclosure. When the change rate of the electric energy or the electric energy value of the electric energy meets the preset requirement, the electric energy activates the communications module such that the communications module reads the collected data from the data collection module. A manner in which the communications module of the terminal reads the collected data from the data collection module may be acquiring an initial address of the collected data and sequentially reading the collected data according to the initial address of the collected data. In this embodiment of the present disclosure, the collected data may be temperature information or a heart rate of a person at some time points, or information about noise in an environment, which is not limited in this embodiment of the present disclosure.

In an optional implementation manner, as shown in FIG. 3, the terminal energy-saving method may further include the following steps:

S305. When detecting that the electric energy is insufficient, the wireless power module of the terminal sends second prompt information that is used to prompt that the electric energy is insufficient to the communications module.

S306. The communications module of the terminal responds to the second prompt information, disconnects the wireless connection, and stops an operation of reading the collected data from the data collection module.

In this embodiment of the present disclosure, when electric energy is insufficient but has not yet used up, a wireless connection is disconnected and an operation of reading collected data from a data collection module is stopped, and unsuccessfully sent data in the collected data is backed up, where the unsuccessfully sent data may still be stored in the data collection module, or may be stored in a nonvolatile memory inside the communications module, which is not limited in this embodiment of the present disclosure. When excitation sent by an external apparatus is responded to the next time and generated electric energy meets a preset requirement, the data unsuccessfully sent the last time and new collected data are sent to the external apparatus.

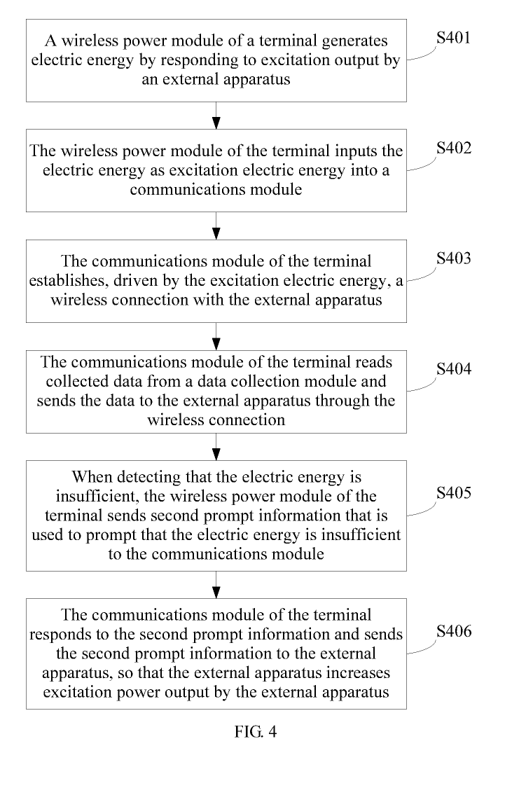

FIG. 4 is a schematic flowchart of still another embodiment of a terminal energy-saving method. The terminal energy-saving method shown in FIG. 4 is applicable to various terminals that have a data collection function, for example, a wearable physiological data (such as blood pressure, body temperature, and heart rate) collecting terminal, a temperature collecting terminal, and an air quality index (such as PM2.5, inhalable particles, sulfur dioxide, nitrogen dioxide, ozone, and carbon monoxide) collecting terminal. As shown in FIG. 4, the terminal energy-saving method may include the following steps:

S401. A wireless power module of a terminal generates electric energy by responding to excitation output by an external apparatus.

In this embodiment of the present disclosure, the external apparatus may output the excitation to the terminal at a specific time interval, or the external apparatus may be triggered, according to a user requirement, to output the excitation to the terminal, which is not limited in this embodiment of the present disclosure. The excitation output by the external apparatus may be a variable magnetic field, or may be a signal that can be converted into electric energy, for example, an optical signal, which is not limited in this embodiment of the present disclosure.

S402. The wireless power module of the terminal inputs the electric energy as excitation electric energy into a communications module.

In an optional implementation manner, that the wireless power module inputs the electric energy as excitation electric energy into a communications module may include the following: the wireless power module may determine whether a change rate of the electric energy is greater than a preset change rate and remains unchanged, if a change rate of the electric energy is greater than a preset change rate and remains unchanged, the wireless power module inputs the electric energy as the excitation electric energy into the communications module, and if a change rate of the electric energy is not greater than a preset change rate and remains unchanged, the wireless power module may ignore the electric energy.

In another optional implementation manner, that the wireless power module inputs the electric energy as excitation electric energy into a communications module may include the following: the wireless power module may determine whether an electric energy value of the electric energy is greater than a preset electric energy value, if an electric energy value of the electric energy is greater than a preset electric energy value, the wireless power module inputs the electric energy as the excitation electric energy into the communications module, and if an electric energy value of the electric energy is not greater than a preset electric energy value, the wireless power module may ignore the electric energy.

In this embodiment of the present disclosure, the wireless power module determines whether the change rate of the electric energy or the electric energy value of the electric energy meets a preset requirement, which can ensure that sufficient electric energy is supplied for communication between the terminal and the external apparatus.

S403. The communications module of the terminal establishes, driven by the excitation electric energy, a wireless connection with the external apparatus.

In this embodiment of the present disclosure, when the change rate of the electric energy or the electric energy value of the electric energy meets the preset requirement, the electric energy activates the communications module such that the communications module establishes the wireless connection with the external apparatus, which makes preparation for sending collected data.

In this embodiment of the present disclosure, the communications module may establish, driven by the excitation electric energy, the wireless connection with the external apparatus, where the wireless connection includes various types of short-range wireless communication, such as a NFC connection, a Bluetooth connection, an infrared connection, and an ultrasonic wave connection.

S404. The communications module of the terminal reads collected data from a data collection module and sends the data to the external apparatus through the wireless connection.

In this embodiment of the present disclosure, the data collection module pre-stores the collected data, and a power supply source of the data collection module may be a storage battery in the terminal, or may be the electric energy generated in step S401, which is not limited in this embodiment of the present disclosure. When the change rate of the electric energy or the electric energy value of the electric energy meets the preset requirement, the electric energy activates the communications module such that the communications module reads the collected data from the data collection module. A manner in which the communications module of the terminal reads the collected data from the data collection module may be acquiring an initial address of the collected data and sequentially reading the collected data according to the initial address of the collected data. In this embodiment of the present disclosure, the collected data may be temperature information or a heart rate of a person at some time points, or information about noise in an environment, which is not limited in this embodiment of the present disclosure.

In an optional implementation manner, as shown in FIG. 4, the terminal energy-saving method may further include the following steps:

S405. When detecting that the electric energy is insufficient, the wireless power module of the terminal sends second prompt information that is used to prompt that the electric energy is insufficient to the communications module.

S406. The communications module of the terminal responds to the second prompt information and sends the second prompt information to the external apparatus such that the external apparatus increases excitation power output by the external apparatus.

In this embodiment of the present disclosure, when it is detected that electric energy is insufficient, a communications module may send second prompt information that is used to prompt that the electric energy is insufficient to an external apparatus such that the external apparatus increases excitation output by the external apparatus, for example, increases a change rate of a magnetic field or increases strength of a signal that can be converted into electric energy, for example, an optical signal. In this way, it is ensured that a terminal can successfully send collected data to the external apparatus.

FIG. 5 is a schematic structural diagram of an embodiment of a terminal. As shown in FIG. 5, a terminal 500 may include a wireless power module 501, a communications module 502, and a data collection module 503, where the wireless power module 501 may include an energy induction submodule 5011 and a power management submodule 5012.

The energy induction submodule 5011 is configured to generate electric energy by responding to excitation output by an external apparatus.

In this embodiment of the present disclosure, the external apparatus may output the excitation to the terminal at a specific time interval, or the external apparatus may be triggered, according to a user requirement, to output the excitation to the terminal, which is not limited in this embodiment of the present disclosure. The excitation output by the external apparatus may be a variable magnetic field, or may be a signal that can be converted into electric energy, for example, an optical signal, which is not limited in this embodiment of the present disclosure.

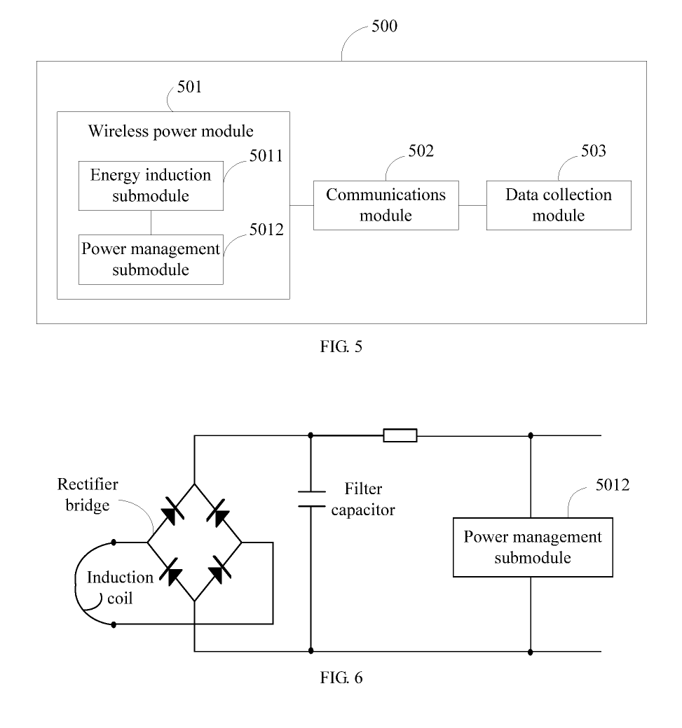

For example, the excitation of the external apparatus may be a variable magnetic field, as shown in FIG. 6. FIG. 6 is a schematic structural diagram of an embodiment of a wireless power module. As shown in FIG. 6, an induction coil, a rectifier bridge, a filter capacitor, and an equivalent resistor may form the corresponding energy induction submodule 5011 in this embodiment of the present disclosure, where the induction coil in the energy induction submodule 5011 may induce the variable magnetic field and generate an electric field (a steady electric field is generated for a magnetic field changing with a constant speed, and a variable electric field is generated for a magnetic field changing with an inconstant speed), and using a rectification function of the rectifier bridge and a filtering function of the filter capacitor, the electric energy is finally stored in the power management submodule 5012.

The power management submodule 5012 is configured to input the electric energy generated by the energy induction submodule 5011 as excitation electric energy into the communications module 502.

In an optional implementation manner, a manner in which the power management submodule 5012 inputs the electric energy generated by the energy induction submodule 5011 as the excitation electric energy into the communications module 502 may be as follows: the power management submodule 5012 may determine whether a change rate of the electric energy is greater than a preset change rate and remains unchanged. If a change rate of the electric energy is greater than a preset change rate and remains unchanged, the power management submodule 5012 inputs the electric energy as the excitation electric energy into the communications module 502, and if a change rate of the electric energy is not greater than a preset change rate and remains unchanged, the power management submodule 5012 may ignore the electric energy.

In another optional implementation manner, a manner in which the power management submodule 5012 inputs the electric energy generated by the energy induction submodule 5011 as the excitation electric energy into the communications module 502 may be as follows: the power management submodule 5012 determines whether an electric energy value of the electric energy is greater than a preset electric energy value. If an electric energy value of the electric energy is greater than a preset electric energy value, the power management submodule 5012 inputs the electric energy as the excitation electric energy into the communications module 502, and if an electric energy value of the electric energy is not greater than a preset electric energy value, the power management submodule 5012 may ignore the electric energy.

In this embodiment of the present disclosure, determining whether the change rate of the electric energy or the electric energy value of the electric energy meets a preset requirement can ensure that sufficient electric energy is provided for communication between the terminal 500 and the external apparatus.

The communications module 502 is configured to establish, driven by the excitation electric energy, a wireless connection with the external apparatus.

In this embodiment of the present disclosure, the communications module 502 may establish, driven by the excitation electric energy, the wireless connection with the external apparatus, where the wireless connection includes various types of short-range wireless communication, such as a NFC connection, a Bluetooth connection, an infrared connection, and an ultrasonic wave connection.

The communications module 502 is further configured to read collected data from the data collection module 503 and send the data to the external apparatus through the wireless connection.

In this embodiment of the present disclosure, the data collection module 503 pre-stores the collected data, a power supply source of the data collection module 503 may be a storage battery in the terminal, or may be the electric energy generated by the energy induction submodule 5011, which is not limited in this embodiment of the present disclosure. When the change rate of the electric energy or the electric energy value of the electric energy meets the preset requirement, the electric energy activates the communications module 502 such that the communications module 502 reads the collected data from the data collection module 503. A manner in which the communications module 502 of the terminal 500 reads the collected data from the data collection module 503 may be acquiring an initial address of the collected data and sequentially reading the collected data according to the initial address of the collected data. In this embodiment of the present disclosure, the collected data may be temperature information or a heart rate of a person at some time points, or information about noise in an environment, which is not limited in this embodiment of the present disclosure.

In an embodiment, the foregoing power management submodule 5012 may be further configured to when detecting that the electric energy is insufficient, send second prompt information that is used to prompt that the electric energy is insufficient to the communications module 502. The communications module 502 may be further configured to respond to the second prompt information, disconnect the wireless connection, and stop an operation of reading the collected data from the data collection module 503.

In this embodiment of the present disclosure, when the electric energy is insufficient but has not yet used up, the wireless connection is disconnected and the operation of reading the collected data from the data collection module 503 is stopped, and unsuccessfully sent data in the collected data is backed up, where the unsuccessfully sent data may still be stored in the data collection module 503, or may be stored in a nonvolatile memory inside the communications module 502, which is not limited in this embodiment of the present disclosure. When the excitation sent by the external apparatus is responded to the next time and the generated electric energy meets the preset requirement, the data unsuccessfully sent the last time and new collected data are sent to the external apparatus.

In another embodiment, the foregoing power management submodule 5012 may be further configured to when detecting that the electric energy is insufficient, send second prompt information that is used to prompt that the electric energy is insufficient to the communications module 502. The communications module 502 may be further configured to respond to the second prompt information and send the second prompt information to the external apparatus such that the external apparatus increases excitation power of the external apparatus.

In this embodiment of the present disclosure, when it is detected that electric energy is insufficient, the communications module 502 sends the second prompt information that is used to prompt that the electric energy is insufficient to the external apparatus such that the external apparatus increases excitation output by the external apparatus, for example, increases a change rate of a magnetic field, or increases strength of a signal that can be converted into electric energy, for example, an optical signal. In this way, it is ensured that the terminal can successfully send the collected data to the external apparatus.

In the terminal 500 shown in FIG. 5, an energy induction submodule 5011 generates electric energy by responding to excitation output by an external apparatus, a power management submodule 5012 inputs the electric energy generated by the energy induction submodule 5011 as excitation electric energy into a communications module 502, and the communications module 502 establishes, driven by the excitation electric energy, a wireless connection with the external apparatus, reads collected data from a data collection module 503, and sends the data to the external apparatus through the wireless connection. In this embodiment of the present disclosure, electric energy may be generated by responding to excitation of an external apparatus, and the generated electric energy may be used to supply power to a terminal for acquiring collected data and for communication between the terminal and the external apparatus, which saves the need of supplying power by a storage battery of the terminal to the terminal for acquiring the collected data and for communication between the terminal and the external apparatus, thereby improving an endurance capability of the storage battery in the terminal.

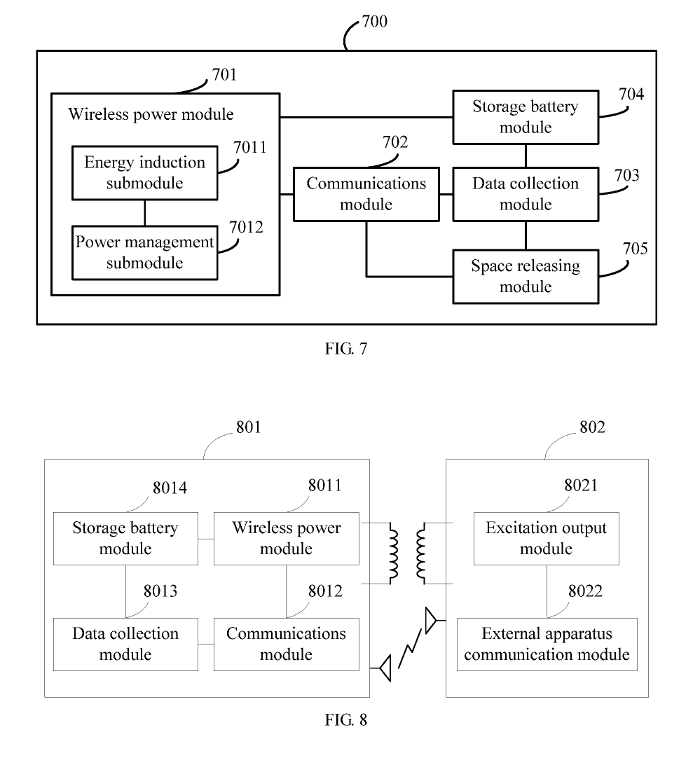

FIG. 7 is a schematic structural diagram of another embodiment of a terminal. As shown in FIG. 7, a terminal 700 may include a wireless power module 701, a communications module 702, and a data collection module 703, where the wireless power module 701 may include an energy induction submodule 7011 and a power management submodule 7012.

The energy induction submodule 7011 is configured to generate electric energy by responding to excitation output by an external apparatus.

The power management submodule 7012 is configured to input the electric energy generated by the energy induction submodule 7011 as excitation electric energy into the communications module 702.

In an optional implementation manner, a manner in which the power management submodule 7012 inputs the electric energy generated by the energy induction submodule 7011 as the excitation electric energy into the communications module 702 may be as follows: the power management submodule 7012 determines whether a change rate of the electric energy is greater than a preset change rate and remains unchanged. If a change rate of the electric energy is greater than a preset change rate and remains unchanged, the power management submodule 7012 inputs the electric energy as the excitation electric energy into the communications module 702, and if a change rate of the electric energy is not greater than a preset change rate and remains unchanged, the power management submodule 7012 may ignore the electric energy.

In another optional implementation manner, a manner in which the power management submodule 7012 inputs the electric energy generated by the energy induction submodule 7011 as the excitation electric energy into the communications module 702 may be as follows: the power management submodule 7012 determines whether an electric energy value of the electric energy is greater than a preset electric energy value. If an electric energy value of the electric energy is greater than a preset electric energy value, the power management submodule 7012 inputs the electric energy as the excitation electric energy into the communications module 702, and if an electric energy value of the electric energy is not greater than a preset electric energy value, the power management submodule 7012 may ignore the electric energy.

In this embodiment of the present disclosure, determining whether the change rate of the electric energy or the electric energy value of the electric energy meets a preset requirement is to ensure that sufficient electric energy is provided for communication between the terminal 700 and the external apparatus.

The communications module 702 is configured to establish, driven by the excitation electric energy, a wireless connection with the external apparatus.

The communications module 702 is further configured to read collected data from the data collection module 703 and send the data to the external apparatus through the wireless connection.

The wireless power module 701 in this embodiment of the present disclosure may be a structure shown in FIG. 6.

In an optional implementation manner, as shown in FIG. 7, the terminal 700 may further include a storage battery module 704.

The storage battery module 704 is configured to supply power to the data collection module 703.

The data collection module 703 is configured to driven by power supply of the storage battery module 704, collect data and store the collected data.

In this embodiment of the present disclosure, the storage battery module 704 of the terminal 700 supplies power for data collection, and the electric energy generated by the energy induction submodule 7011 supplies power for acquiring collected data and for communication between the terminal 700 and the external apparatus. Power consumption required for data collection is relatively low, and power consumption required for sending the collected data to the external apparatus is relatively high. Such a power supply manner in which power supply for data collection is differentiated from power supply for acquiring and sending the collected data can greatly improve an endurance capability of the storage battery in the terminal.

In an optional implementation manner, the communications module 702 may be further configured to receive first prompt information that is sent by the external apparatus and is used to prompt that the data is successfully received.

The power management submodule 7012 is further configured to respond to the first prompt information and send remaining electric energy to the storage battery module 704 such that the storage battery module 704 stores the remaining electric energy.

In this embodiment of the present disclosure, when the electric energy generated by the energy induction submodule 7011 by responding to the excitation output by the external apparatus is greater than electric energy consumed by the communications module 702, the power management submodule 7012 may further send the remaining electric energy to the storage battery module 704, and the remaining electric energy stored in the storage battery module 704 may supply power to the data collection module 703. For example, when the communications module 702 sends all collected data to the external apparatus, the communications module 702 is in a sleep state in which no or only a little electric energy is consumed. In this case, the power management submodule 7012 transmits, to the storage battery module 704, most electric energy generated by responding to the excitation output by the external apparatus.

In an optional implementation manner, the communications module 702 may be further configured to respond to the first prompt information, disconnect the wireless connection, and stop an operation of reading the collected data from the data collection module 703.

Power consumption of the wireless connection between the terminal 700 and the external apparatus is very high. When the terminal 700 successfully sends the collected data to the external apparatus, the terminal 700 disconnects the wireless connection with the external apparatus and stops the operation of reading the collected data from the data collection module 703 of the terminal 700, which can save electric energy.

As shown in FIG. 7, the terminal 700 may further include a space releasing module 705, where the space releasing module 705 is configured to respond to the first prompt information and release storage space that is used to store the collected data and is in the data collection module 703.

When the terminal 700 successfully sends the collected data to the external apparatus, the terminal 700 deletes the storage space that is in the data collection module 703 and is used to store the successfully sent data, which may save storage space so as to store collected data next time.

In this embodiment of the present disclosure, a communications module 702 starts to work under excitation of excitation electric energy, and the communications module 702 sends collected data that is read to the external apparatus through a wireless connection established between the communications module 702 and an external apparatus. When an energy induction submodule 7011 of a wireless power module 701 of a terminal 700 does not receive excitation of the external apparatus, the communications module 702 does not work, that is, the communications module 702 does not read the collected data nor establishes the wireless connection with the external apparatus. Physically, the communications module 702 and a circuit interface of a data collection module 703 are in a high impedance state, and because a current is extremely small in the high impedance state, the communications module 702 does not become load of the data collection module 703, nor consumes electric energy that supplies power to the data collection module 703. Implementation of this embodiment of the present disclosure brings the following beneficial effects: A terminal may generate electric energy by responding to excitation of an external apparatus, the generated electric energy is used to supply power to the terminal for acquiring collected data and for communication between the terminal and the external apparatus, a storage battery in the terminal supplies power for data collection. In such a separate power supply manner, an endurance capability of the storage battery is improved, and in addition, the storage battery can also store remaining electric energy, which further improves the endurance capability of the storage battery. After the communication between the terminal and the external apparatus ends, successfully sent data is deleted and storage space for the successfully sent data is released, which may save storage space.

FIG. 8 is a schematic structural diagram of an embodiment of a system. As shown in FIG. 8, the system may include a terminal 801 and an external apparatus 802, where the terminal 801 may include a wireless power module 8011, a communications module 8012, and a data collection module 8013.

The wireless power module 8011 is configured to generate electric energy by responding to excitation output by the external apparatus 802, and input the electric energy as excitation electric energy into the communications module 8012.

In this embodiment of the present disclosure, the wireless power module 8011 may be shown in FIG. 6, optionally, the excitation output by the external apparatus 802 may be a variable magnetic field, or may be a signal that can be converted into electric energy, for example, an optical signal, which is not limited in this embodiment of the present disclosure.

In an optional implementation manner, a manner in which the wireless power module 8011 inputs the electric energy as the excitation electric energy into the communications module 8012 may be as follows: the wireless power module 8011 determines whether a change rate of the electric energy is greater than a preset change rate and remains unchanged. If a change rate of the electric energy is greater than a preset change rate and remains unchanged, the wireless power module 8011 inputs the electric energy as the excitation electric energy into the communications module 8012, and if a change rate of the electric energy is not greater than a preset change rate and remains unchanged, the wireless power module 8011 may ignore the electric energy.

In another optional implementation manner, a manner in which the wireless power module 8011 inputs the electric energy as the excitation electric energy into the communications module 8012 may be as follows: the wireless power module 8011 determines whether an electric energy value of the electric energy is greater than a preset electric energy value, if an electric energy value of the electric energy is greater than a preset electric energy value, the wireless power module 8011 inputs the electric energy as the excitation electric energy into the communications module 8012, and if an electric energy value of the electric energy is not greater than a preset electric energy value, the wireless power module 8011 may ignore the electric energy.

The communications module 8012 is configured to establish, driven by the excitation electric energy, a wireless connection with the external apparatus 802.

The communications module 8012 is further configured to read collected data from the data collection module 8013 and send the data to the external apparatus 802 through the wireless connection.

In an optional implementation manner, as shown in FIG. 8, the terminal 801 may further include a storage battery module 8014.

The storage battery module 8014 is configured to supply power to the data collection module 8013.

The data collection module 8013 is configured to driven by power supply of the storage battery module 8014, collect data and store the collected data.

In an optional implementation manner, when the electric energy generated by the wireless power module 8011 by responding to the excitation output by the external apparatus 802 is greater than electric energy consumed by the communications module 8012, the wireless power module 8011 may be further configured to send remaining electric energy to the storage battery module 8014 such that the storage battery module 8014 stores the remaining electric energy and supplies power to the data collection module 8013. For example, after the communications module 8012 sends all collected data to the external apparatus 802, the communications module 8012 is in a sleep state in which no or only a little electric energy is consumed. In this case, the wireless power module 8011 transmits, to the storage battery module 8014, most electric energy generated by responding to the excitation output by the external apparatus 802.

As shown in FIG. 8, the external apparatus 802 may include an excitation output module 8021 and an external apparatus communications module 8022.

The excitation output module 8021 is configured to output excitation to the terminal 801 such that the terminal 801 generates the electric energy by responding to the excitation.

In this embodiment of the present disclosure, the excitation output module 8021 outputs the excitation to the terminal 801, that is, the excitation output module 8021 outputs the excitation to the wireless power module 8011 of the terminal 801.

The external apparatus communications module 8022 is configured to establish the wireless connection with the terminal 801.

In this embodiment of the present disclosure, the external apparatus communications module 8022 may establish the wireless connection with the communications module 8012 of the terminal 801.

The external apparatus communications module 8022 is further configured to receive data collected and sent by the terminal 801 through the wireless connection.

In this embodiment of the present disclosure, the external apparatus communications module 8022 may further receive the collected data sent by the communications module 8012 of the terminal 801 through the wireless connection.

Implementation of this embodiment of the present disclosure brings the following beneficial effects: A terminal may generate electric energy by responding to excitation of an external apparatus, the generated electric energy may be used to supply power to the terminal for acquiring collected data and for communication between the terminal and the external apparatus, a storage battery in the terminal supplies power for data collection. In such a separate power supply manner, an endurance capability of the storage battery is improved, and in addition, the storage battery can also store remaining electric energy, which further improves the endurance capability of the storage battery.

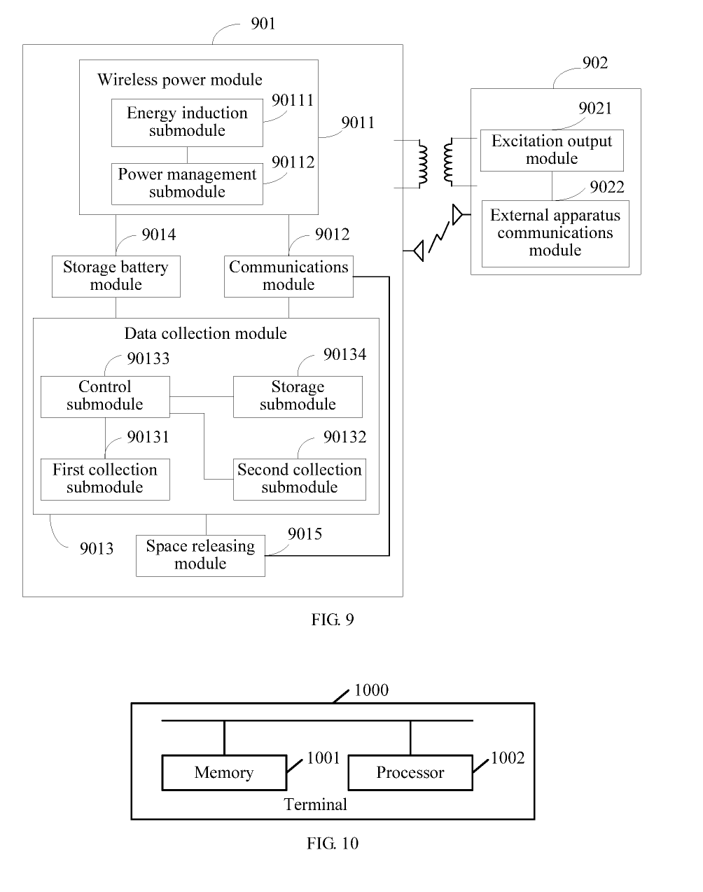

FIG. 9 is a schematic structural diagram of still another embodiment of a system. As shown in FIG. 9, the system may include a terminal 901 and an external apparatus 902, where the terminal 901 may include a wireless power module 9011, a communications module 9012, and a data collection module 9013, and the external apparatus 902 may include an excitation output module 9021 and an external apparatus communications module 9022.

The wireless power module 9011 is configured to generate electric energy by responding to excitation output by the excitation output module 9021 of the external apparatus 902, and input the electric energy as excitation electric energy into the communications module 9012.

In an optional implementation manner, the wireless power module 9011 may include an energy induction submodule 90111 and a power management submodule 90112, where the energy induction submodule 90111 is configured to generate the electric energy by responding to the excitation output by the excitation output module 9021 of the external apparatus 902, and the power management submodule 90112 is configured to input the electric energy generated by the energy induction submodule 90111 as the excitation electric energy into the communications module 9012.

The communications module 9012 is configured to establish, driven by the excitation electric energy, a wireless connection with the external apparatus communications module 9022.

The communications module 9012 is further configured to read collected data from the data collection module 9013 and send the data to the external apparatus communications module 9022 through the wireless connection.

In an optional implementation manner, as shown in FIG. 9, the terminal 901 may further include a storage battery module 9014.

The storage battery module 9014 is configured to supply power to the data collection module 9013.

The data collection module 9013 is configured to driven by power supply of the storage battery module 9014, collect data and store the collected data.

In an optional implementation manner, the data collection module 9013 may include a first collection submodule 90131, a second collection submodule 90132, a control submodule 90133, and a storage submodule 90134.

The first collection submodule 90131 and the second collection submodule 90132 are configured to collect data.

In this embodiment of the present disclosure, the data collection module 9013 may further include another collection submodule, which is configured to collect other data and is not shown in FIG. 9 in this embodiment of the present disclosure.

In this embodiment of the present disclosure, the collection submodule may be a sensor, and the like, which is not limited in this embodiment of the present disclosure.

The control submodule 90133 is configured to process data collected by the first collection submodule 90131 and the second collection submodule 90132, and send processed data to the storage submodule 90134.

In this embodiment of the present disclosure, the control submodule 90133 may be a processor, and the like, and the control submodule 90133 may have a standby mode and a wakeup mode. Before the data collected by the collection submodule is generated, the control submodule 90133 may be in a standby state, and after the collected data is generated, the collection submodule wakes up the control submodule 90133 such that the control submodule 90133 processes the collected data from the collection submodule.

In this embodiment of the present disclosure, the terminal 901 may control each collection submodule to trigger a data collection operation at the same time, in this case, the control submodule 90133 may be waked up once such that the control submodule 90133 is in the wakeup mode, which can save electric energy.

The storage submodule 90134 is configured to store the processed data sent by the control submodule 90133.

In this embodiment of the present disclosure, the storage submodule 90134 may be a memory, and the storage submodule 90134 may include a port that enables the communications module 9012 to acquire the collected data.

In an optional implementation manner, the communications module 9012 may be further configured to receive first prompt information that is sent by the external apparatus communications module 9022 and is used to prompt that the data is successfully received.

The power management submodule 90112 may be further configured to respond to the first prompt information and send remaining electric energy to the storage battery module 9014 such that the storage battery module 9014 stores the remaining electric energy.

In an optional implementation manner, the communications module 9012 is further configured to respond to the first prompt information, disconnect the wireless connection, and stop an operation of reading the collected data from the storage submodule 90134 of the data collection module 9013.

As shown in FIG. 9, the terminal 901 may further include a space releasing module 9015, where the space releasing module 9015 is configured to respond to the first prompt information and release storage space that is used to store the collected data and is in the storage submodule 90134.

In this embodiment of the present disclosure, after the storage space, for the collected data, in the storage submodule 90134 is released, the storage submodule 90134 may send, to the control submodule 90133, a message that is used to prompt that the storage space may be reused.

In an embodiment, when detecting that the electric energy is insufficient, the power management submodule 90112 may be further configured to send second prompt information that is used to prompt that the electric energy is insufficient to the communications module 9012.

The communications module 9012 is further configured to respond to the second prompt information, disconnect the wireless connection, and stop an operation of acquiring the collected data from the storage submodule 90134 of the data collection module 9013.

In another embodiment, the communications module 9012 is further configured to respond to the second prompt information and send the second prompt information to the external apparatus communications module 9022 such that the external apparatus 902 increases excitation power output by the excitation output module 9021.

Implementation of this embodiment of the present disclosure brings the following beneficial effects: A terminal may generate electric energy by responding to excitation of an external apparatus, the generated electric energy is used to supply power to the terminal for acquiring collected data and for communication between the terminal and the external apparatus, a storage battery in the terminal supplies power for data collection. In such a separate power supply manner, an endurance capability of the storage battery is improved, and in addition, the storage battery can also store remaining electric energy, which further improves the endurance capability of the storage battery. After the communication between the terminal and the external apparatus ends, successfully sent data is deleted and storage space for the successfully sent data is released, which may save storage space.

FIG. 10 is a schematic structural diagram of still another terminal disclosed in an embodiment of the present disclosure. As shown in FIG. 10, the terminal 1000 may include a memory 1001 and a processor 1002, where the memory 1001 stores a group of program code, and the processor 1002 may be configured to invoke the program code stored in the memory 1001 to execute the following operations: generating electric energy by responding to excitation output by an external apparatus, establishing, driven by the electric energy, a wireless connection with the external apparatus, and reading collected data and sending the data to the external apparatus through the wireless connection.

In an embodiment, before the processor 1002 reads the collected data and sends the data to the external apparatus through the wireless connection, the processor 1002 is configured to invoke the program code stored in the memory 1001 and is further configured to execute the following operation: collecting data and storing the collected data.

In an embodiment, the processor 1002 is configured to invoke the program code stored in the memory 1001 and is further configured to execute the following operations: receiving first prompt information that is sent by the external apparatus and is used to prompt that the data is successfully received, and responding to the first prompt information and storing remaining electric energy.

In an embodiment, the processor 1002 is configured to invoke the program code stored in the memory 1001 and is further configured to execute the following operation: responding to the first prompt information, disconnecting the wireless connection, stopping an operation of reading the collected data, and releasing storage space that is used to store the collected data and is in the processor 1002.

In an embodiment, the processor 1002 is configured to invoke the program code stored in the memory 1001 and is further configured to execute the following operation: detecting whether the electric energy is insufficient, and when detecting that the electric energy is insufficient, disconnecting the wireless connection and stopping an operation of reading the collected data.

Implementation of this embodiment of the present disclosure brings the following beneficial effects: A terminal may generate electric energy by responding to excitation of an external apparatus, the generated electric energy may be used to supply power to the terminal for acquiring collected data and for communication between the terminal and the external apparatus, remaining electric energy may be stored, which improves an endurance capability of the terminal. After the communication between the terminal and the external apparatus ends, successfully sent data is deleted and storage space for the successfully sent data is released, which may save storage space.

A data collection module in the foregoing embodiments may include a processor, a memory, and one or more collectors (for example, a sensor), a communications module in the foregoing embodiments may include an acquiring submodule and a radio-frequency submodule, and a power management module in the foregoing embodiments may be a controller, which are not limited in this embodiment.

It should be noted that, in the foregoing embodiments, the descriptions of the embodiments have their respective focuses. For a part that is not described in detail in an embodiment, reference may be made to related descriptions in other embodiments. In addition, a person skilled in the art may also understand that all the embodiments described in this specification belong to embodiments, and the involved actions and modules are not necessarily mandatory for the present disclosure.

Combination, deletion, and sequence adjustment may be performed on steps in the method of the embodiments of the present disclosure according to an actual requirement.

Combination, division, and deletion may be performed on modules or submodules in the apparatus of the embodiments of the present disclosure according to an actual requirement.

The modules or submodules in the embodiments of the present disclosure may be implemented using a universal integrated circuit, such as a central processing unit (CPU) or an application specific integrated circuit (ASIC).

In the embodiments of the present disclosure, the foregoing embodiments of the terminal only describe basic modules required for implementing the terminal energy-saving method, the terminal, and the system that are disclosed in the embodiments of the present disclosure, and modules such as a housing, a display, a loudspeaker, a microphone, a keyboard, and an antenna that are included in the terminal are not described in the embodiments of the present disclosure.

In the embodiments of the present disclosure, the foregoing embodiments of the external apparatus only describe basic modules required for implementing the terminal energy-saving method, the terminal, and the system that are disclosed in the embodiments of the present disclosure, and modules that are related to data storage, processing, and display and are included in the external apparatus are not described in the embodiments of the present disclosure.

What is claimed is:

1. A terminal, comprising:
a memory;
a communications module;
a wireless power module comprising:
an energy induction submodule configured to generate electric energy by responding to excitation output by an external apparatus; and
a power management submodule configured to input the electric energy generated by the energy induction submodule as excitation electric energy into a communications module;
wherein the communications module is coupled to the memory and the wireless power module, and
wherein the communications module comprises a first processor configured to:
establish, driven by the excitation electric energy, a wireless connection with the external apparatus; and
read collected data from the memory; and
send the data to the external apparatus through the wireless connection.

2. The terminal according to claim 1, wherein the terminal further comprises:
a battery configured to supply power to the data collection module;
a receiver, driven by a power supply of the battery, configured to collect data; and
a memory, driven by a power supply of the battery, configured to store the collected data.

3. The terminal according to claim 2, wherein the power management submodule comprises a processor configured to:
determine, by the power management submodule, whether a change rate of the electric energy is greater than a preset change rate and remains unchanged;
input the electric energy as the excitation electric energy into the communications module when the change rate of the electric energy is greater than the preset change rate and remains unchanged; or
determine, by the power management submodule, whether an electric energy value of the electric energy is greater than a preset electric energy value; and
input the electric energy as the excitation electric energy into the communications module when the electric energy value of the electric energy is greater than the preset electric energy value.

4. The terminal according to claim 2, wherein the communications module comprises a first receiver configured to receive first prompt information from the external apparatus that is used to prompt that the data is successfully received, and wherein the power management submodule comprises a second transmitter configured to:
respond to the first prompt information; and
send remaining electric energy to the battery such that the battery stores the remaining electric energy.

5. The terminal according to claim 4, wherein the communications module further comprises a first transmitter coupled to the first processor and configured to respond to the first prompt information, wherein the first processor of the communications module is further configured to:
disconnect the wireless connection; and
stop an operation of reading the collected data from the data collection module; and
release storage space that is used to store the collected data and is in the data collection module.

6. The terminal according to claim 1, wherein a transmitter of the power management submodule is configured to send second prompt information that is used to prompt that the electric energy is insufficient to the communications module when the electric energy is insufficient, and wherein when receiving the second prompt information, the first processor of the communications module is further configured to:
disconnect the wireless connection; and
stop an operation of reading the collected data from the data collection module.

7. The terminal according to claim 1, wherein a transmitter of the power management submodule is configured to send second prompt information that is used to prompt that the electric energy is insufficient to the communications module when the electric energy is insufficient, and wherein when receiving the second prompt information, the first processor of the communications module is further configured to send the second prompt information to the external apparatus such that the external apparatus increases excitation power output by the external apparatus.

8. A terminal, comprising:
a memory and
a processor coupled to the memory, wherein the memory stores a group of program code, and the processor is configured to invoke the program code stored in the memory to:
generate electric energy by responding to excitation output by an external apparatus;
establish, driven by the electric energy, a wireless connection with the external apparatus;
read collected data; and
send the data to the external apparatus through the wireless connection.

9. The terminal according to claim 8, wherein before the processor reads the collected data and sends the data to the external apparatus through the wireless connection, the processor is further configured to:
collecting the data; and
storing the collected data.

10. The terminal according to claim 9, wherein the processor is further configured to:
receive first prompt information that is sent by the external apparatus and is used to prompt that the data is successfully received;
respond to the first prompt information; and
store remaining electric energy.

11. The terminal according to claim 10, wherein the processor is further configured to:
respond to the first prompt information;
disconnect the wireless connection;
stop an operation of reading the collected data; and
release storage space that is used to store the collected data.

12. The terminal according to claim 8, wherein the processor is configured to invoke the program code stored in the memory and is further configured to:
detecting whether the electric energy is insufficient; and
disconnecting the wireless connection when the electric energy is insufficient; and
stopping an operation of reading the collected data when the electric energy is insufficient.

13. A terminal energy-saving method, comprising:
generating electric energy by responding to excitation output by an external apparatus;
inputting the electric energy as excitation electric energy into a communications module;
establishing a wireless connection with the external apparatus;
reading collected data; and
sending the data to the external apparatus through the wireless connection.

14. The method according to claim 13, wherein before reading the collected data from the data collection module, and sending the data to the external apparatus through the wireless connection, the method further comprises:
supplying, by a battery, power;
collecting the data; and
storing the collected data.

15. The method according to claim 14, wherein inputting the electric energy as excitation electric energy comprises:
determining whether a change rate of the electric energy is greater than a preset change rate and remains unchanged;
inputting the electric energy as the excitation electric energy when the change rate of the electric energy is greater than the preset change rate and remains unchanged;
determining whether an electric energy value of the electric energy is greater than a preset electric energy value; and
inputting the electric energy as the excitation electric energy when the electric energy value of the electric energy is greater than the preset electric energy value.

16. The method according to claim 14, wherein the method further comprises:
receiving first prompt information that is sent by the external apparatus and is used to prompt that the data is successfully received; and
responding to the first prompt information; and
sending remaining electric energy to the battery such that the battery stores the remaining electric energy.

17. The method according to claim 16, wherein the method further comprises:
responding to the first prompt information;
disconnecting the wireless connection,
stopping an operation of reading the collected data;
responding to, by a space releasing module, the first prompt information; and
releasing storage space that is used to store the collected data.

18. The method according to claim 13, wherein the method further comprises:
sending second prompt information that is used to prompt that the electric energy is insufficient to the communications module when the electric energy is insufficient;
responding to the second prompt information when the electric energy is insufficient;
disconnecting the wireless connection when the electric energy is insufficient; and
stopping an operation of reading the collected data when the electric energy is insufficient.

19. The method according to claim 13, wherein the method further comprises:
sending second prompt information that is used to prompt that the electric energy is insufficient when the electric energy is insufficient;
responding to the second prompt information when the electric energy is insufficient;
sending the second prompt information to the external apparatus such that the external apparatus increases excitation power output by the external apparatus when the electric energy is insufficient.
